(19) United States
(12) Patent Application Publication
(10) Pub. No.: US 2026/0314542 A1
(43) Pub. Date: Oct. 15, 2026

(54) LOW-STRESS PLANT TRAINING DEVICE

(71) Applicant: John George Sieve, JR., Leslie, MO (US)

(72) Inventor: John George Sieve, JR., Leslie, MO (US)

(21) Appl. No.: 19/177,321

(22) Filed: Apr. 11, 2025

(51) Int. Cl. A01G 5/00; A01G 9/12

(52) U.S. Cl. CPC A01G 9/128

(57) ABSTRACT

A plant training apparatus for controlled manipulation of plant stems includes first and second arms pivotally connected to each other, with a gear disposed on the first arm and a pawl disposed on the second arm configured to engage with the gear. Each first arm and second arm includes a post with a recessed middle section designed to receive and hug a plant stem. First and second arms are rotatable relative to each other to bend the plant stem positioned between the posts, with the pawl configured to engage the gear to lock the first and second arms in selected positions.

### FIELD OF THE DISCLOSURE

The present invention relates to horticulture training devices, specifically to apparatuses for low-stress training of plant stems and branches. More particularly, the invention pertains to an adjustable mechanical device utilizing a gear and pawl mechanism for incremental, directional manipulation of plant growth to optimize light exposure, airflow, and structural development in cannabis cultivation, bonsai shaping, fruit tree training, and related applications.

### BACKGROUND OF THE INVENTION

Plant training techniques have been utilized for centuries across various horticultural applications, from ornamental bonsai cultivation to agricultural crop management. The fundamental purpose of such techniques is to manipulate plant structure to optimize growth patterns, increase yield, improve light penetration, enhance airflow, and create aesthetically pleasing forms. In commercial applications, particularly cannabis cultivation, plant training has become increasingly sophisticated as growers seek to maximize production efficiency and crop quality.

Traditional plant training methods have relied on rudimentary tools and approaches. The earliest techniques involved simple tying or weighing down of branches using string, wire, or weights. These manual methods, while effective to some degree, often resulted in inconsistent results and required constant adjustment as plants grew. More importantly, these techniques frequently caused damage to plant tissues through abrasion, strangulation, or breakage, leading to stress responses that could negatively impact plant health and productivity.

As horticultural practices evolved, particularly in specialized fields such as bonsai cultivation and commercial agriculture, more refined training tools emerged. Wire-based training systems became the standard for bonsai, allowing practitioners to gradually shape branches over extended periods. In commercial settings, trellising systems, netting, and stakes became common for controlling plant architecture. The cannabis cultivation industry adopted Screen of Green (SCROG) techniques utilizing netting to create even canopies for maximum light exposure.

The development of plastic clips, ties, and adjustable stakes represented the next evolution in plant training technology. These products offered improved convenience and reduced damage compared to earlier methods. However, these solutions still presented significant limitations. Most notably, they typically provided only fixed-position training with limited two-handed adjustability, requiring frequent removal and repositioning as plants developed. This continuous manipulation increased the risk of damage and disease transmission while consuming valuable labor resources.

Current market solutions include various plastic clips, soft plant ties, and training wires. While these products have improved upon earlier methods, they still suffer from several critical deficiencies. Fixed-direction training devices limit flexibility in canopy management. Traditional clips and ties often apply inconsistent pressure, creating potential damage points on stems. Many existing solutions require complete removal and repositioning to make adjustments, increasing plant stress and labor requirements. Furthermore, most training devices provide only temporary solutions, with limited durability and reusability.

Perhaps the most significant gap in current technology is the inability to provide incremental, progressive training without removing and reapplying devices. Plant training is most effective and least stressful when applied gradually over time, yet existing tools rarely facilitate this approach. Additionally, current solutions generally lack multi-directional capability, restricting growers to predetermined bending directions that may not optimize light exposure or space utilization.

Another critical limitation of existing technology is the inability to maintain consistent tension as plants grow and stems thicken. Most current devices either restrict growth, potentially damaging the plant, or become loose and ineffective as the plant develops. This necessitates constant monitoring and adjustment, increasing labor costs and the risk of plant damage.

The object of the present invention is therefore to provide an improved plant training device that addresses these limitations through an adjustable, incremental training mechanism. Specifically, the invention aims to deliver a durable, reusable device that enables precise, multi-directional control of plant growth without causing damage to plant tissues. By incorporating a gear and pawl mechanism preferably with a large center spool or hub for gentle, gradual bends and for incremental adjustments without removal, the invention seeks to minimize plant stress while maximizing training effectiveness. The device is designed to accommodate the natural growth patterns of plants while maintaining consistent, appropriate tension throughout the training process, thereby improving plant health, reducing labor requirements, and optimizing growing space utilization.

### SUMMARY OF THE INVENTION

In some aspects, the present invention provides a plant training apparatus comprising pivotally connected first and second arms, each supporting posts with recessed middle sections configured to gently engage a plant stem while enabling controlled manipulation of the stem's direction and angle.

Some embodiments describe a gear mechanism disposed on the first arm that cooperates with a pawl mechanism on the second arm, creating a ratcheting system allowing incremental adjustments to the bend angle while maintaining secure positioning during plant growth.

Other aspects of the invention include specially designed posts extending from each arm with concave, recessed middle sections that distribute pressure evenly across the plant stem surface, reducing the risk of damage while ensuring sufficient contact to maintain the desired position.

Further, the invention incorporates a unique gear and pawl engagement system that allows for precise, incremental adjustments without requiring removal of the device from the plant stem, enabling gradual training that minimizes stress and optimizes growth patterns.

In additional embodiments, at least one post is rotatable relative to its supporting arm, providing enhanced adaptability as the plant grows and changes orientation, while maintaining the established bend angle determined by the arm positions.

Some aspects may include a spring mechanism integrated with the pawl that ensures consistent engagement with the gear teeth while accommodating variations in pressure and resistance during adjustment and growth cycles.

Embodiments describe a full 360-degree rotation capability between the first and second arms, enabling multi-directional training options in both vertical and horizontal planes, significantly expanding the range of possible stem orientations compared to conventional training devices.

In particular embodiments, the pivotal connection between the first and second arms incorporates a retention pin that secures the assembly while allowing smooth rotation during adjustments, ensuring structural integrity without impeding functionality.

Other aspects include a one-handed operation design that enables growers to make adjustments while supporting the plant with their free hand, improving efficiency and reducing the risk of accidental damage during the training process.

Further aspects relate to the distribution of force across the plant stem through the engineered geometry of the posts' recessed sections, preventing localized pressure points that could damage vascular tissues while maintaining sufficient tension for effective training.

Some embodiments include integrated rotation limiters that prevent over-rotation beyond the device's mechanical capabilities, protecting both the device and the plant from excessive force application.

In further embodiments, the entire apparatus is constructed from UV-resistant, durable plastic materials specifically selected to withstand greenhouse and outdoor growing environments, ensuring longevity and consistent performance across multiple growing cycles.

Even further, the invention features a staggered configuration of the posts when closed around a stem, creating an offset pattern that enhances grip security while reducing the risk of stem slippage during adjustment or external disturbances.

Certain aspects include a pawl design with multiple engagement points, ensuring secure locking even under tension from actively growing plants attempting to straighten against the training pressure.

Other embodiments describe an ergonomic design that accommodates stems of varying diameters, from young, thin stems to mature, thickened branches, making the device versatile across different growth stages and plant varieties.

In additional aspects, the invention's gear teeth are precisely engineered to maintain secure positioning while still allowing for smooth transitions between incremental positions, balancing security with adjustability.

Further embodiments include a method of use wherein growers can progressively increase the bend angle over time by making small, incremental adjustments that allow the plant to adapt gradually, reducing stress responses and potential growth inhibition.

Some aspects provide for the simultaneous use of multiple devices on different branches of the same plant, creating comprehensive canopy management without the need for additional supporting structures such as trellises or screens.

Embodiments describe the invention's application across various horticultural practices beyond cannabis cultivation, including bonsai training, fruit tree branch management, and ornamental plant shaping, demonstrating its versatility as a universal plant training solution.

In final aspects, the invention represents a significant advancement over traditional plant training methods by combining incremental adjustability, multi-directional capability, and plant-friendly design features in a single, reusable device that reduces labor requirements while improving training outcomes and plant health.

### BRIEF DESCRIPTION OF THE DRAWINGS

The accompanying drawings, which are incorporated in and constitute a part of this specification, illustrate exemplary embodiments of the plant training apparatus and, together with the description, serve to explain the principles of the invention. The drawings are provided for illustrative purposes only and are not drawn to scale. In the drawings:

FIG. 1A is an exemplary view of a stress training device positioned around a straight twig prior to bending.

FIG. 1B is an exemplary view of the stress training device adjusted to create a partially bent twig.

FIG. 1C is an exemplary view of the stress training device adjusted to create a maximally bent twig.

FIG. 2A is an exploded view showing the internal components of the stress training device including the retention pin, geared arm, posts, pawl, and pawled arm.

FIG. 2B is an assembled view of the gear and pawl mechanism that enables incremental position locking of the stress training device.

FIG. 3 illustrates a non-limiting view of a pawl mechanism incorporating protective elements according to one aspect of the invention.

### DETAILED DESCRIPTION OF PREFERRED EMBODIMENTS

The following description of preferred embodiments refers to the accompanying drawings, which illustrate specific embodiments of the invention. Other embodiments having different structures and operations do not depart from the scope of the present invention. The same reference numbers may be used in the drawings and the following description to refer to the same or like parts.

As used herein, the terms “comprising,” “including,” “containing,” “characterized by,” and grammatical equivalents thereof are inclusive or open-ended and do not exclude additional, unrecited elements or method steps, unless otherwise stated. Other than in the operating examples, or where otherwise indicated, all numbers expressing quantities, dimensions, and other parameters used in the specification and claims are to be understood as being modified in all instances by the term “about,” meaning within a reasonable range of the indicated value. The terms “a” and “an” refer to one or more of the elements described, whereas the term “plurality” refers to two or more of the elements described, unless the context clearly indicates otherwise.

The adjustable plant training device described herein provides novel solutions for low-stress training of plant stems using a gear and pawl mechanism that enables incremental, directional manipulation. The invention may incorporate advanced mechanical features including rotatable posts with recessed middle sections, a spring-biased pawl system, and 360-degree adjustability to enable highly effective plant training while minimizing damage to plant tissues. The following detailed description, along with the accompanying drawings, provides a comprehensive understanding of the various embodiments and aspects of the invention.

This invention addresses the challenges of training plant stems in a precise, adjustable, and plant-friendly manner. By leveraging the gear and pawl mechanism with incrementally adjustable positions, the invention prevents the need for frequent repositioning and reduces the risk of plant damage, thereby improving plant health and growth outcomes. The system further integrates specialized features such as concave-recessed posts and staggered configurations to enhance grip security while distributing pressure evenly across plant stems.

The invention's ability to maintain secure positioning while allowing for progressive adjustments represents a significant advancement in the field of horticultural training. By enabling multi-directional, incremental training, the invention supports a wide range of applications, including cannabis cultivation, bonsai shaping, fruit tree branch management, and ornamental plant training. The integration of rotatable components and spring mechanisms further enhances the adaptability of the system, enabling more accurate and comprehensive control of plant architecture.

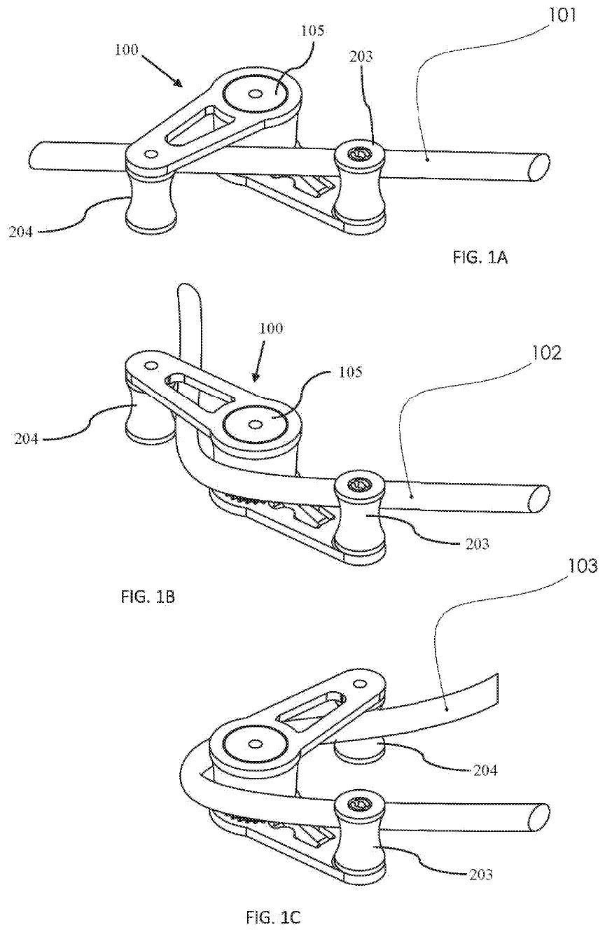

Firstly, FIG. 1A illustrates an exemplary embodiment of a stress training device 100 in accordance with aspects of the present invention, wherein the device may be positioned around a substantially straight twig 101 prior to the application of bending force. In a non-limiting embodiment, the stress training device 100 may comprise a first post 203 having a recessed mid section that may be configured to partially surround and engage with a portion of the twig 101. Secondly, the device 100 may further include a second post 204, which may also include a recessed mid section that may be designed to contact the twig 101 from a generally opposing direction relative to the first post 203. The embodiment depicted in FIG. 1A may demonstrate how the recessed portions of posts 203 and 204 may cooperatively cradle the twig 101 while maintaining the twig in a substantially unbent orientation.

In another aspect of the invention, a pivot 105 may rotatably connect components of the device 100, wherein the pivot may serve as an axis of rotation that may permit relative movement between the first post 203 and second post 204. The exemplary configuration shown in FIG. 1A may represent an initial state of the device 100 prior to any training adjustments, wherein the gear and pawl mechanism (not explicitly labeled in this view) may be in a neutral or minimally engaged position. In some implementations, the device 100 may be constructed from durable, lightweight materials that may withstand various environmental conditions while providing sufficient structural integrity to effectively train plant stems of various diameters.

Secondly, FIG. 1B depicts an exemplary embodiment of the stress training device 100 wherein the device may be adjusted to create a partially bent twig 102, demonstrating an intermediate stage of the plant training process. In a non-limiting embodiment, the first post 203 and second post 204 may have been partially rotated relative to each other around pivot 105, which may cause a moderate deflection in the orientation of the twig 102. The recessed mid sections of posts 203 and 204 may continue to cradle the twig 102 while distributing pressure across a sufficient surface area, which may help minimize localized stress that could potentially damage plant tissues. The embodiment shown in FIG. 1B may illustrate how the gear and pawl mechanism (not explicitly shown in this view) may be partially engaged to maintain this intermediate position, wherein the pawl may be secured against one of several gear teeth to prevent unwanted movement back toward the original straight position.

In a further exemplary embodiment, FIG. 1C illustrates the stress training device 100 adjusted to create a maximally bent twig 103, which may represent the full range of bending capability of this particular embodiment. The first post 203 and second post 204 may be rotated to a more extreme relative position around pivot 105, which may create a more pronounced directional change in the twig 103. This configuration may be particularly useful for applications requiring significant redirection of plant growth, such as creating horizontal branching patterns or redirecting stems away from neighboring plants. The pivot 105 may function as a fulcrum point around which the bending force is applied, while the recessed mid sections of posts 203 and 204 may continue to provide supportive contact surfaces that may reduce the risk of stem damage even at maximum deflection angles. In some implementations, the maximally bent position shown in FIG. 1C may be securely maintained by the complete engagement of the pawl with a corresponding gear tooth positioned farther along the gear arc, which may prevent any unintended return to less extreme positions even as the plant exerts natural straightening pressure against the device 100.

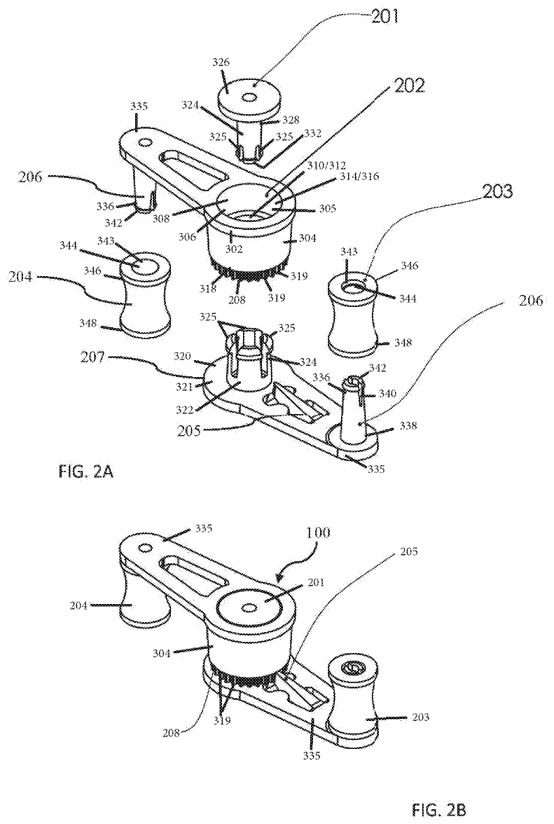

In another exemplary embodiment, FIG. 2A may illustrate an expanded view of the internal components that may comprise the stress training device 100, revealing the structural elements that may enable its adjustable functionality. The retention pin 201 may serve as a central connecting element that may secure the assembly while still allowing for rotational movement between components. In some implementations, a geared arm 202 may extend outward from a central pivot point and may include structures that may support the first post 203, which may feature a recessed mid section designed to partially encircle and engage with a plant stem. The exemplary configuration may further include a second post 204 with a similar recessed mid section that may be supported by structures extending from the opposing side of the device. A pawl 205 may be positioned to interact with gear teeth, wherein the pawl may be biased toward engagement through a spring mechanism that may apply consistent pressure to maintain position once adjusted. The post mount or center hub or spool 206 may provide a stable platform from which the posts may extend, and in some embodiments, the post mount may allow for rotational adjustment of the posts independent of the arm movement to accommodate changes in stem orientation during growth. A pawled arm 207 may extend opposite to the geared arm 202, wherein the pawled arm may house or support the pawl 205 in a position that may facilitate proper engagement with corresponding gear teeth.

In certain non-limiting implementations, the components depicted in FIG. 2A may be manufactured from durable, UV-resistant materials that may withstand greenhouse or outdoor growing environments while maintaining functional integrity. The arrangement of these components may create a mechanical system wherein rotational movement between the geared arm 202 and pawled arm 207 may be precisely controlled through incremental engagement positions defined by the interaction between the pawl 205 and gear teeth, which may enable growers to make precise, gradual adjustments to plant stem orientation without removing and repositioning the device.

In a detailed embodiment, FIG. 2B may provide a close-up perspective of critical mechanical components that may enable the incremental adjustment functionality of the stress training device 100. The gear 206 may be formed with a series of precisely spaced teeth that may be arranged in an arc pattern, wherein each tooth may represent a potential locking position for the device. In some implementations, the gear 206 may include between 10 and 30 teeth, though other quantities may be suitable depending on the desired precision of adjustment. The pawl 205 may comprise a resilient engaging member that may be configured to interact with the teeth of gear 206, wherein the pawl may include a contact surface that may be shaped to complement the geometry of the gear teeth for secure engagement. In certain non-limiting examples, the pawl 205 may be biased toward engagement with the gear 206 through a spring mechanism that may apply consistent pressure throughout the adjustment range. The interaction between pawl 205 and gear 206 may create a ratcheting system that may allow for movement in one rotational direction while potentially preventing backward movement unless the pawl is intentionally disengaged.

The exemplary configuration shown in FIG. 2B may illustrate how these components may work together to maintain the stress training device 100 in selected positions even when subjected to forces from growing plants attempting to return to their natural orientation. In some embodiments, the gear 206 and pawl 205 may be manufactured from materials with different hardness properties, which may help distribute wear across the engagement surfaces and may potentially extend the operational lifespan of the device through multiple growing seasons.

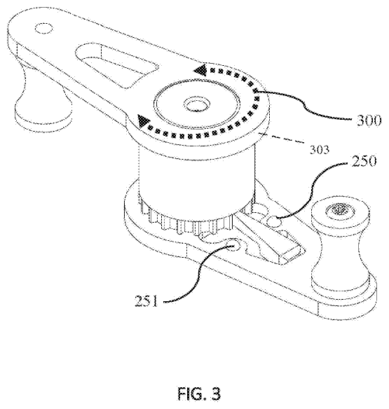

In an exemplary embodiment, FIG. 3 may illustrate a detailed view of the pawl mechanism incorporating protective elements that may prevent excessive wear during operation of the stress training device. The arrow 300 may indicate the potential rotary movement that may occur during adjustment of the device. A first bump or raised element 250 may be positioned on one side of the pawl on the second arm, wherein this raised element may act as a mechanical stop or wear-prevention feature during rotation in one direction. In complementary fashion, a second bump 251 may be positioned on an alternate side of the pawl, which may provide similar protective functionality during rotation in the opposite direction.

In some implementations, the pawl may incorporate a spring-biased mechanism, wherein a small spring may apply continuous pressure on the pawl, keeping it pressed against the gear teeth at all times. This spring-biased configuration may ensure that the pawl automatically snaps into position and remains engaged with the gear teeth without requiring manual holding or external pressure. Such an arrangement may provide reliable locking functionality through multiple adjustment cycles and may contribute to the overall ease of use of the device.

The strategic positioning of elements 250 and 251 on alternate sides may create a balanced system that may prevent excessive bending regardless of the direction of rotational force applied during plant training adjustments, while the spring-biased mechanism may ensure consistent engagement between the pawl and gear teeth throughout the operational life of the device.

### INDUSTRIAL APPLICATION

The stress training device described herein has significant industrial applications across multiple horticultural sectors. In commercial cannabis cultivation, the device may substantially reduce labor costs associated with plant training while potentially increasing yields through optimized canopy development. Nurseries and greenhouse operations may utilize the device for efficient structural management of ornamental and food-producing plants, potentially improving marketability and production efficiency. The bonsai and specialized plant cultivation industries may benefit from the device's precision adjustment capabilities, allowing for professional-grade aesthetic development with reduced maintenance requirements. Research institutions studying plant phototropism and structural development may employ the device to create controlled, reproducible training conditions. The reusable nature of the device may further enhance its industrial value by reducing recurring material costs in large-scale growing operations.

1. A plant training apparatus for holding and guiding portions of a plant in order to manipulate plant structure to optimize growth and maximize production efficiency, the plant training apparatus comprising:
a first geared arm that carries at one end thereof a cylindrical housing which may extend at a perpendicular angle relative to the first geared arm, wherein the cylindrical housing includes an opening therein which forms an inner surface that includes a lower inner surface with a smaller diameter relative to an upper inner surface having a larger diameter, and an opposite end of the cylindrical housing including a gear which includes a plurality of teeth;
a second arm pawled arm that carries at one end thereof a tapered cylindrical housing that extends at a perpendicular angle relative to the second pawled arm, wherein an upper end of the tapered cylindrical housing includes a plurality of cupped fingers extending axially above the tapered cylindrical housing, and wherein at least a portion of the cylindrical housing of the first geared arm is configured to extend axially over at least a portion of the tapered cylindrical housing of the second pawled arm;
a retention pin, wherein at least a portion of the retention pin is configured to be positioned into the larger diameter of the opening of the cylindrical housing of the first geared arm, the retention pin formed to include a disk positioned perpendicularly relative to the retention pin at one end thereof, and including a plurality of protrusions formed about an opposite end thereof, and an elongated portion extending therebetween,
wherein when the first geared arm is positioned over the second pawled arm, the plurality of cupped fingers of the tapered cylindrical housing are moved through the smaller diameter of the lower inner surface of the first geared arm into a position against at least a portion of the larger diameter of the upper inner surface, to assist holding the first geared arm to the second pawled arm,
wherein the retention pin is desirably configured to be positioned into the larger diameter of the opening of the cylindrical housing of the first geared arm in order to contact at least a portion of the plurality of cupped arms of the tapered cylindrical housing of the second pawled arm,
wherein the plurality of cupped fingers of the tapered cylindrical housing are also formed to hold the elongated portion of the retention pin therebetween when the retention pin is inserted into and the cylindrical housing, the end of the retention pin with the plurality of protrusions thereon is formed to move at least through at least a portion of the plurality of cupped fingers, the plurality of protrusions on the end of the retention pin formed to assist in holding the elongated portion of the retention pin between the plurality of cupped fingers, and the disk of the retention pin formed to be positioned into the opening in the cylindrical housing of the first geared arm and against at least a portion of a perimeter thereof, such that the retention pin and the plurality of cupped fingers of the tapered cylindrical housing cooperate with the upper inner surface of the first geared arm to rotatably connect the first geared arm and the second pawled arm together,
a pair of spools, one of each spool of the pair of spools positioned at opposing ends of each of the first geared arm and the second pawled arm, respectively, wherein each spool of the pair of spools includes a first end and a second end, and the first end of each spool includes a split therein and a lip formed on each side of the split across the first end of each spool;
a first post and a second post, wherein the first post is positioned over one spool of the pair of spools and the second post is positioned over the other spool of the pair of spools, and at least the lip of each spool is positioned against a perimeter of an opening in a first end of each of the first post and second post, respectively, to hold each of the respective first post and second post on its respective spool; and
a pawl, the pawl carried by the second pawled arm, the pawl configured to contact the gear on the first geared arm.

2-6. (canceled)

7. The plant training apparatus of claim 1, wherein each first geared arm and second pawled arm formed to include a surface upon which the cylindrical housing of the first geared arm and upon which the tapered cylindrical housing of the second geared arm are carried, and wherein the surface of each of the first geared arm and the second geared arm extends beyond the cylindrical housing and the tapered cylindrical housing, respectively, and wherein when the first geared arm and the second pawled arm are connected together, the surface of the second pawled arm extends beyond and away from the cylindrical housing and the gear thereon of the first geared arm.

8. The plant training apparatus of claim 1, wherein the first post and the second post each include a recessed middle section configured to distribute pressure evenly across the plant stem to prevent damage.

9. The plant training apparatus of claim 1, wherein when the first geared arm and the second pawled arm are rotated relative to each other, the pawl is configured to releasably lock the first geared arm and the second geared arm in a fixed position relative to each other via contact between the pawl and at least a portion of a plurality of teeth of the gear.

10. (canceled)

11. A method of training a plant comprising positioning a plant stem between a first post having a recessed middle section extending from a first arm and a second post having a recessed middle section extending from a second arm, wherein the first and second arms are pivotally connected to each other, rotating the first arm relative to the second arm to bend the plant stem, and engaging a pawl on the second arm with a gear on the first arm to lock the first and second arms in a selected rotational position relative to each other.

12. The method of claim 11, further comprising incrementally adjusting the bend in the plant stem over time by disengaging the pawl from the gear, rotating the first arm relative to the second arm to a new position, and re-engaging the pawl with the gear.

13. The method of claim 11, further comprising rotating at least one of the first post and the second post to accommodate changes in the orientation of the plant stem during growth while maintaining the selected rotational position of the first and second arms.

14. The method of claim 11, further comprising training multiple plant stems on a single plant using multiple plant training apparatuses to create a uniform canopy structure optimized for light penetration.

15. The method of claim 11, further comprising periodically adjusting the rotational position of the first and second arms as the plant grows to maintain optimal stem orientation without removing the apparatus from the plant stem.

16. The method of claim 11, further comprising rotating the entire plant training apparatus approximately 360 degrees around the plant stem to redirect growth in a different direction while maintaining the selected bend angle.
